(19) United States
(12) Patent Application Publication
(10) Pub. No.: US 2024/0032450 A1
(43) Pub. Date: Feb. 1, 2024

(54) MODULAR TOOL SYSTEM FOR SOIL CULTIVATION

(71) Applicant: TECHNISCHE UNIVERSITÄT DRESDEN, Dresden (DE)

(72) Inventors: Thomas HERLITZIUS, Dresden (DE); André GROSA, Dresden (DE); Mario HENKE, Dresden (DE); Martin HENGST, Dresden (DE); Jonathan KRESS, Lößnitz/Erzgebirge (DE)

(73) Assignee: TECHNISCHE UNIVERSITÄT DRESDEN, Dresden (DE)

(21) Appl. No.: 18/251,485

(22) PCT Filed: Nov. 1, 2021
(86) PCT No.: PCT/EP2021/080269

§ 371 Date: May 2, 2023

(30) Foreign Application Priority Data
Nov. 2, 2020 (DE) 10 2020 128 749.6

(51) Int. Cl. A01B 63/10; A01B 79/00

(52) U.S. Cl. CPC A01B 63/10; A01B 79/005

(57) ABSTRACT

The invention relates to a device comprising: at least one tool module (4) having a quick-coupling interface (19); at least one support having a quick-coupling interface (19) and designed to hold the at least one tool module; and at least one data processing unit designed for computer-assisted tool management. The support for holding the tool module (4) comprises at least one support frame (16), at least one interface (21) for computer-assisted tool module identification, and at least one sensor unit. The support frame comprises at least one quick-coupling interface (19) for a tool module. The tool module comprises at least one implement (18) for use outdoors, at least one suspension that is compatible with the quick-coupling point on the support frame, at least one computer-readable storage medium (22) for computer-readable data, and at least one interface for transmission of computer-readable data. During the work processes the condition of the tools is detected by means of a pertaining tool management system and stored in a storage medium. Each tool module is unambiguously associated with a storage medium.

The invention relates to a tool system for agricultural processes and for soil cultivation.

Complex machines for different agricultural processes/tasks are known from the prior art. In general, machines are the more efficient the lower their downtimes. This applies also, and in particular, to agricultural and forestry technology since the limited harvesting times allow for only narrow time windows. In order to reduce downtimes, tools are often modularized and the downtime is thus transferred from the entire machines to storable tools.

U.S. Pat. No. 3,971,446 A discloses a multifunctional agricultural machine in this context. This multifunctional agricultural machine is intended for performing several agricultural tasks, such as planting, fertilizing and harvesting, if applicable “soil cultivation.” The multifunctional character eliminates the need to invest in individual specific machines. The disclosed agricultural machine in this case comprises a vehicle with a driver's cab for an operator, a motor which both moves the vehicle and delivers part of its power to a lateral interface. Furthermore, replaceable work units, such as sprayers, planters or harvesters, can be attached. These are supported by additional, removable and laterally extendable supporting arms which are controlled by the vehicle.

DE 10 2017 201 425 A1 discloses an autonomous agricultural robot machine for performing one or more agricultural operations. The machine has a frame with a length and an adjustable width. A plurality of soil engaging mechanisms are coupled to the frame for driving the machine in a running direction. The machine further comprises a controller, a power generating device and a generator, wherein the controller controls the machine. The generator receives mechanical power from the power generating device and generates electrical power. Furthermore, a docking assembly is coupled to the frame. Said docking assembly includes a power unit and at least one coupling for coupling a plurality of agricultural implements.

US 2013 0199 807 A1 describes an adaptable agricultural implement for soil cultivation. Said agricultural implement has a frame with a plurality of fastening or mounting surfaces. Here, it is provided to releasably couple a variety of replaceable soil cultivation modules to said mounting surfaces. Depending on soil cultivation requirements, the replaceable soil cultivation modules can be arranged in a given order.

DE 10 2010 005 183 B4 discloses a soil cultivation device. Said soil cultivation device comprises at least one attachable machine frame and is suitably coupled to a tractor. On the soil engaging tool unit formed in this way, various soil cultivation tools, in particular rows of tines and/or rows of disks or grubbers and/or harrows which are suspended on the machine frame, are connected by means of the attachable machine frame to a trailing roller and to a working-depth adjuster for adjusting the working depth of the soil engaging tool unit. In addition, the overall system has a trailing height adjuster for adjusting the height of the trailing roller relative to the machine frame. Both the working-depth adjuster and the trailing height adjuster have a pressure fluid drive, which thus ensures continuous working-depth adjustment and of the trailing height adjuster.

Tools for coupling or tool systems of this type are subject to a wide variety of signs of wear or can be at least heavily damaged, or even destroyed, during use for soil cultivation, as a result of which, in the absence of adequate correction, the individual tools lose their optimum operating condition within the scope of their application. Furthermore, the assembly and disassembly of the individual tools or tool modules is associated with a still considerable expenditure of time.

The object of the invention is to overcome the disadvantages of the prior art and to propose a user-friendly tool system.

The object is achieved by the features of the independent claims. Preferred embodiments are the subject of the dependent claims, which refer back in each case.

According to the invention, the device comprises at least one tool module having a quick-coupling interface, at least one support having a quick-coupling interface and designed to hold the at least one tool module, and at least one data processing unit designed for computer-assisted tool management. The support, which has at least one quick-coupling interface and is suitable for holding the tool module, comprises at least one support frame, at least one interface for computer-assisted tool module identification, and at least one sensor unit.

The support frame comprises at least one quick-coupling interface for a tool module. The tool module, in turn, comprises at least one implement, preferably for use outdoors, at least one suspension that is compatible with the quick-coupling point on the support frame, at least one computer-readable storage medium for computer-readable data and at least one interface for transmission of computer-readable data.

Tool management or a tool management system is understood to mean computer-assisted measures for managing and/or controlling the tool modules. This is implemented, for example, but not exclusively, by means of a database on a data processing system. The individual tools are each unambiguously identified and parameters relevant to the user are associated with the tools.

Tool module identification is understood to mean preferably computer-readable information which is suitable for storing and reproducing a wide variety of parameters of the tool module or even of the individual tools of the tool module. The computer-assisted tool module identification is preferably, but not exclusively, contactless so that the information for tool module identification can be transmitted wirelessly. The tool module identification is stored in the computer-readable storage medium.

A computer-readable storage medium is understood to mean local physical storage media (for example, but not limited to, hard disks, RFID tags, USB flash memories or QCR codes, barcodes) and also non-local memories (IT cloud solutions). The parameters relating to the tool module can be located on the storage medium.

Hereinafter, the parameters of the tool module are understood to mean, inter alia, tool module ID, usage time, working time, tool dimensions, nominal working speed, nominal working depth, working behavior of the tools (active/passive), particular setting parameters (for example rotational speed), number of individual tools/working regions, tool module wear, individual tool (EW) ID, EW: actual wear, wear limit, displacement, deformation, loss, position. These parameters of the tool module are intended to be stored in the computer-readable storage medium. It is also conceivable to store only a selection of said parameters. In concepts with non-local storage media (e.g., IT cloud solution), at least the tool ID must be stored.

The parameters of the tool control include, for example: positioning of the tool module in space, rotational speed/feed/slip of active (moving) tools, control of application rates. Adaptations in case of wear or repositioning during cornering and/or changes in the soil condition close to the tool are carried out, for example, on the basis of the parameters of the tool control.

Hereinafter, a quick-coupling interface is understood to mean a mechanical coupling between a tool module and the support frame. The mechanical coupling can be formed, for example, by a related bayonet lock or the like; coupling can take place without tools, for example, and coupling can take place automatically, for example. However, the coupling is not limited to the aforementioned examples.

Furthermore, at least one interface for data transmission and/or at least one interface for (electrical, hydraulic, pneumatic) energy transfer and/or at least one interface for media transfer (seed, fertilizer, etc.) is provided at defined locations relative to the mechanical coupling. These relative positions are preferably formed mirror-symmetrically on tool module and support frame.

In order to convey the tool modules, with and without storage boxes, construction, agricultural and municipal machines (for example, tractor with front/rear three-point hitch or front loader, telescopic, wheel and farm loader), floor conveyors (for example, forklifts, lift trucks) or other mobile or stationary lifting equipment (for example, hoists, cranes, winches) can be used.

The position of the working tools is dependent on the respective process and the geometry of the tools used. The position of the working tools in each case relates to the working height parameter in case of above-ground tool applications (for example, mower, mulcher) or to the working depth parameter in case of tool applications in the ground (e.g., grubber, plow, disk harrow). Active position guidance of the tools results in exact compliance with the parameters (working height/depth) and ensures a consistently good work result.

Depending on the work process and the desired work result, it may be necessary or expedient to use trailing rollers/packers. This is why the support is provided with an additional interface for holding a trailing roller/packer.

In embodiments of the invention, the support frame of the support is designed to be adjustable and/or controllable. Control units are provided for control. These control units are realized preferably, but not exclusively, through a data processing device.

In embodiments of the invention, the support for holding the tool module is designed to be adjustable mechanically, electromechanically or in a pressure-actuated manner. The adjusting devices also comprise combinations of the mechanical, electromechanical or pressure-actuated embodiments. For example, the support is supplied with hydraulic oil by means of a pump driven by an electric motor or an internal combustion engine, wherein the pressure and volume flow can be variable or constant. In case of need, a hydraulic actuator performs the adjustment of the support frame and tool module. Subsequently, a further actuator can set a bolt to secure the two parts. This is advantageous since robust adjustment mechanisms can be realized in this way.

In embodiments of the invention, the quick-coupling interface is designed to adapt the tool module to the soil profile and to operate it such as to be tiltable preferably along one axis, particularly preferably along two axes and, in particular, preferably in three axes. Furthermore, the tool module is movable and adjustable preferably along at least one additional degree of freedom. The tool module is in particular preferably designed to move in all of its six degrees of freedom (three axes of rotation and three translational axes). The interaction of sensor system and data processing unit recognizes the coupled tool and controls or adjusts automatically, by means of suitable actuators, its orientation and/or inclination relative to the surrounding terrain, in particular during cornering and/or in case of bumps in the ground.

For this purpose, the distance to the ground surface is determined by means of sensor units and adjusted by means of kinematics and, if necessary, controlled in such a way that the desired working depth is achieved. Since special devices, such as mulchers or mowers, are moved directly on the ground surface, it is thus possible to advantageously use a wide variety of tool modules with the support frame according to the invention. This, in turn, leads to an economic and logistical advantage since only the tool modules having only at least one support frame have to be procured.

In embodiments of the invention, the quick-coupling interface between the support and the tool module comprises at least one kinematics and/or at least one actuator. This is advantageous since it allows for variable depth guidance. Thus, depth guidance of the soil cultivation tools, for example, is controlled via the kinematics of the tool module. For this purpose, on the one hand, the distance between the ground and a reference point, for example on the support frame, is determined via a corresponding sensor system. This sensor system can operate in a contactless manner or with contact. On the other hand, the current position of the adjustment mechanisms or associated actuators is determined. The target working depth can be set through the position of the actuators of the kinematics, the geometric relationships of sensor system, tool and support frame, and the current distance between the ground and the one reference point. This makes it possible to respond to bumps in the ground, and it advantageously allows for an active change in height during operation.

This is advantageous since, due to traction-dependent working-depth changes which are caused by the resilience of the tools (e.g., tines/stone protection), are compensated for and result in reduced wear of the tools.

In embodiments of the invention, the sensor unit is selected from inductive sensors, capacitive sensors, acceleration sensors or optical sensors. This also includes, without limitation, sensor units of combinations of inductive, capacitive and/or optical sensors.

In embodiments of the invention, the support is designed to be mounted on a chassis or traveling assembly. The chassis or traveling assembly is associated with a tractive unit and/or comprises at least one means for coupling to a tractive unit. The chassis, traveling assembly or vehicle is designed for mechanical, electromechanical or pressure-induced adjustment of the working height of the tool module.

Chassis or parts of chassis also include trailing members such as, for example, but not limited to, trailing rollers or packers.

In embodiments of the invention, an additional support or tool support is designed as a storage device. This storage device is preferably designed to be stackable.

These easily transportable tools advantageously facilitate maintenance of the tool components.

This is advantageous since, in this way, stationary or mobile storage is possible during transport and maintenance, as necessary. In particular in an autonomous application in which the chassis or traveling assembly is designed for autonomous movement, a wide variety of tools can be kept available for the autonomous units in the immediate vicinity of their area of application.

In conjunction with the various adjustment mechanisms, the respective region to be maintained can advantageously be moved to a comfortable working height by suitably tilting or inclining the tool modules.

In embodiments of the invention, an additional support is designed as a storage device. The storage device is designed for preferred transport by lifting equipment, floor conveyors or agricultural machines is. For this purpose, the storage device has standardized connection points (e.g., tractor three-point hitch or Euro attachment front loader) and/or transport/lifting/forklift plates. This is advantageous since the selection of a suitable transport system is thus also highly modular.

In embodiments of the invention, the tool module comprises at least one interface for power transmission and/or an autonomous energy supply. This is advantageous since it allows for modularization of movable and/or active tools with a non-zero power input. Furthermore, simplified functional testing is made possible during maintenance operation.

Furthermore, these active tools can be used for additional momentum or for additional feed.

The method of computer-assisted tool management comprises the following steps:
a) detecting a target condition of at least one tool,
b) storing the information about the target condition of the respective tool in computer-readable form,
c) detecting the actual condition of at least one tool,
d) storing the information about the actual condition of the respective tool in computer-readable form,
e) identifying correlated target and actual conditions,
f) comparing correlated target and actual conditions,
g) outputting a prediction concerning the future actual condition of the respective tool, and
h) deriving and outputting an action recommendation regarding the respective tool,
   wherein computer-assisted tool management differentiates at least between the following action recommendations:
no action required,
action required due to destruction/loss,
action required due to contamination,
action required due to wear, and
action required due to insufficient data availability.

The detection of the target condition takes place as follows:
based on previously known geometric data on the measuring range, for example by CAD data, manufacturing data, tool positions input by the operator, and/or
a new target condition is defined on the basis of a measurement run with an actual condition.

In embodiments of the invention, the computer-readable information of the target and/or actual condition is selected from the list: type of at least one tool, area of application of the tool, previous operating time of the tool, geometric arrangement of at least one tool component, identification feature of the tool component and/or wear of the tool component.

In embodiments of the invention, the comparison of the target/actual information the condition detection takes place. It transmits the information (correction tool position, single tool deformed/missing . . . ) to the tool management. As a result, tool management responds by adapting the tool position and/or reporting to the operator and/or reporting to superordinate systems.

In embodiments of the invention, the parameters of the tool module are stored in a storage medium. After installation of the tool module in the support frame, the information is transmitted from the tool module to the data processing unit of the tool management. Tool management recognizes the following on the basis of the parameters: the type of tool, previous operating time, current measure of wear, which parameters for subsequent operation are to be assumed by the support platform. This is, for example, the working depth and/or the operating speed. During operation, the mounted sensor system monitors the tools operating in the process. Monitoring can take place continuously or sporadically. Sporadic monitoring is realized, for example, in that all parameters of the tools are assessed only when the tool module is taken off.

If changes are detected by the system, a recommendation for action may be given depending on the severity of the changes. The tool management system autonomously evaluates the severity of the change in that it performs, for example (but not exclusively), a data comparison with the history of the data stored in the storage medium. The wear can thus be detected on the basis of a long-term trend. Brief changes, such as contamination or destruction of the tool, can also be registered and detected in this way. Depending on the severity of the detected change, a direct feedback is given to the user, or this change is transferred as a new characteristic number into the tool management system. In any case, the changes are stored in the storage medium of the tool module. This has the advantage that a manipulation of tools is thus made more difficult.

In embodiments of the invention, the information is stored on an RFID tag. Possible information is the unique tool module ID, parameters on geometry, wear conditions, operating points, etc.

In embodiments of the invention, data relating to the geometric nature of the tool are stored in the storage medium. These can be measurement data of the new tool, digitized construction data or image data. This advantageously provides a stable comparison basis with respect to changes. This comparison basis is advantageously used for self-reference.

In order to realize the invention, it is also expedient to combine the above-described embodiments and features of the claims.

The invention is described below in figures as exemplary embodiments.

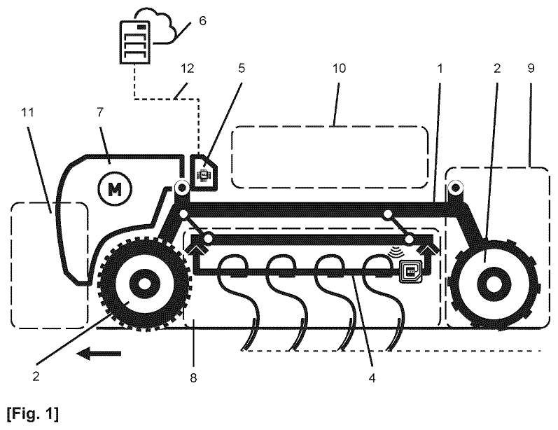

FIG. 1: FIG. 1 schematically shows an exemplary design of the machine system in a self-propelled embodiment. Different installation spaces, which are characterized by ((8), ((9), ((10) and ((11), are shown in the general overview. For example, but not exclusively, further support frames for tool modules, storage options for operating equipment or operating materials and/or trailing or support members of a chassis can be placed in the installation spaces. The machine system has a support/main frame ((1) to which all essential components are fastened. The system is supported on front drive wheels and on non-driven rear wheels of the chassis. In this example, rolling and/or compressing working devices are schematically provided, which are height-adjustable. They are connected via the interface to the support/main frame ((1) and are thus replaceable and exchangeable. The main operation preferably takes place in installation space 1 ((8) and is performed by a tool or tool group in modular design ((4). In the further installation spaces 2 to 4, symbolized by ((9), ((10) and ((11), can also be used to fulfill the task or other tasks. The respective mountable devices are connected to the support/main frame ((1) via a quick-coupling point according to the invention. The self-propelled embodiment has an independent module for energy supply ((7) for providing necessary energy. The various modules for energy supply ((7) are, for example, but not limited to, internal combustion engines, battery-electric storages with electric motor and/or a fuel cell with a coupled electric motor. The control, regulation, monitoring of the driving and work process is carried out via a control device and/or an on-board computer ((5) of a so-called ECU. This system can communicate with a computer-readable storage medium according to the invention for computer-readable data ((6) via an interface according to the invention for the transmission of computer-readable data ((12). During the work process, the system preferably moves at one speed. In case that the work process includes soil cultivation, the working depth, which is conditional on the tool ((4) and the soil to be cultivated, is set. The information required for height adjustment is provided by the control device and/or on-board computer ((5).

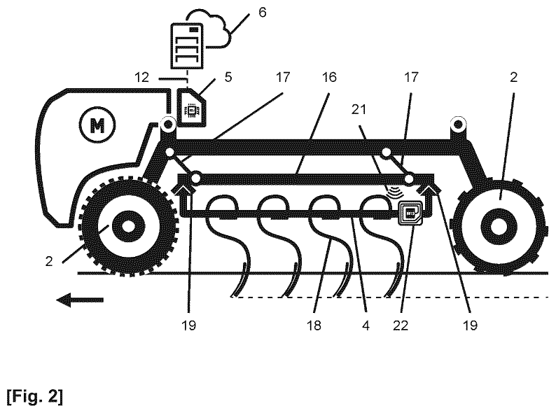

FIG. 2 schematically shows the exemplary design of the machine system in a self-propelled embodiment analogous to FIG. 1, wherein here, too, the tool module ((4) is shown in a lowered state. Height adjustment of the tool or tool group in modular design ((4) takes place in the installation space 1 ((8) via a coupling mechanism ((17). A coupling frame ((16), to which the tool or tool group in modular design ((4) is fastened via an interface with a quick coupler ((19), is moved vertically. On the module side, the tool or tool group in modular design ((4) has a storage medium for computer-readable data ((22) which can be read out and written on by the machine system via a data interface ((21). The read-out information is processed by the control device and/or on-board computer ((5) and used to control the work process.

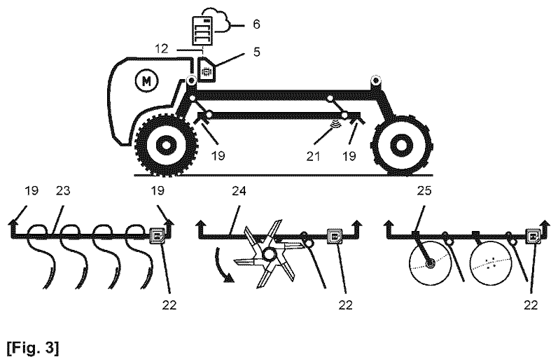

FIG. 3 schematically shows various tools or tool groups in modular design next to one another and by way of example, without limitation. In the designation from left to right, it is a tine tool, an actively driven tool and a disk tool. The various tools or tool groups in modular design can be coupled to the support/main frame ((1) according to the invention via the interface ((19). Furthermore, an information storage ((22) is symbolized which allows for automated recognition via a data interface ((21) on the tool support side and the control device or on-board computer ECU ((5). Unambiguous identification of the tools/tool modules/process modules can take place via the data interface ((21) and the ((22) storage medium for computer-readable data on the module side. In addition, tool conditions, operating/device parameters or other process/machine information can be stored, which can be used for process/machine control by the control device or on-board computer ((5). Alternatively, these data can also be obtained in the form of an IT cloud solution, more generally from a non-local computer-readable storage medium ((6), via the interface according to the invention for data transmission of computer-readable data ((12).

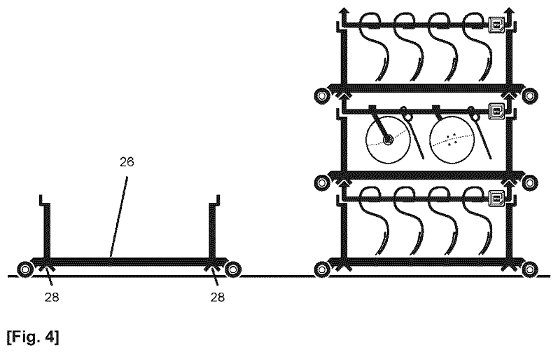

FIG. 4 schematically shows a device for storing ((26) at least one tool or tool group in modular design ((4) if they are not installed in the machine system according to the invention. In addition to storing, the illustrated device for storing also serves for storage, transport and maintenance/repair. Stackability advantageously allows for space-saving storage and logistics. The individual or stacked boxes can be moved by corresponding stationary or mobile machines and devices. A device for storing is shown on the left-hand side, which device does not accommodate any tools or tool groups in modular design ((4). Three storage devices are stacked on the right-hand side and are each loaded with a tool or tool group in modular design ((4).

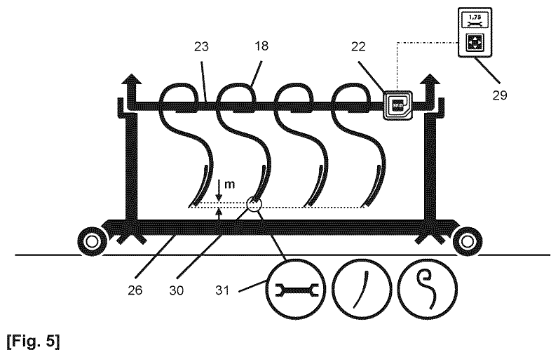

FIG. 5 schematically shows the exemplary action recommendations ((31) which were stored according to the method according to the invention by the control unit, the on-board computer ((5) and/or the operator/technician/administrator on the local ((22) or non-local storage ((6). In case of need ((30), the corresponding instructions ((31) for the specific case will be read out. This information is read out manually or automatically by a corresponding reading device with a communication interface ((29). In addition, this information can also be stored by means of a data transmission, according to the invention, of computer-readable data ((12) in a storage medium according to the invention for computer-readable information ((6), for example also non-locally in an IT cloud, and can be used for organizing and carrying out the work. If the corresponding work has been completed, the actual condition of the tools is stored in the storage medium for computer-readable data ((22) on the module side.

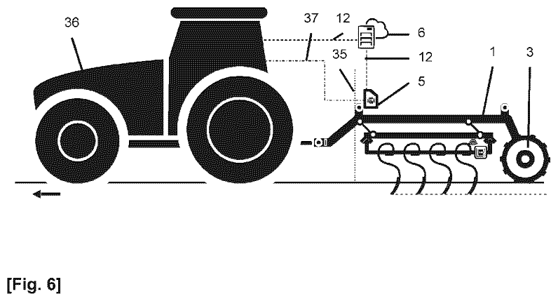

According to FIG. 6, the machine system can also be operated by a towing vehicle, in this example designed as a standard tractor ((36). The design, functionality and modularity does not necessarily change in comparison to the self-propelled variant. It is possible to suspend or hold the on-board energy supply ((7) and the front chassis at a mechanical interface for operation with a towing vehicle ((35), separately from the support/main frame ((1). Coupling to the standard tractor ((36) takes place, for example, but not exclusively, via a drawbar in the tractor lower link, a pivot drawbar in the trailer hitch or ((42). The towing vehicle ((36) generates the required traction and supplies the machine system with, inter alia, energy via a supply line ((37). Furthermore, the supply line ((37) is used for communication or as a data connection between the control device or the on-board computer ECU ((5) and the standard tractor ((36). There is always the possibility for the standard tractor ((36) to communicate via an interface for the data transmission of computer-readable data ((12) with a computer-readable storage medium for computer-readable data ((6), for example, and without limitation, in a non-local embodiment of an IT Cloud, and to receive control and process information. This information is provided to the on-board computer ECU ((5) by the supply line ((37). Conversely, depending on the design of the standard tractor ((36), the ECU ((5) can transmit control commands and/or current process data, such as speed, route, current position, provision of energy/data, via the supply line ((37) to said tractor. In case of runs that do not take place as part of the work process, the front region of the machine system can be taken off by means of an actuator.

In one exemplary embodiment, a drawn variant according to FIG. 6 is described in detail. An embodiment of a standard tractor permissible in Germany is used as a towing vehicle.

The modular machine system is coupled to the towing vehicle (36) by means of a standard quick-coupling interface. The towing vehicle (36) supplies the machine system with energy (for example, electrically, hydraulically, mechanically) (37), has an interface (37) for communication and data transmission with the modular support, and generates the required traction to manage the task. In addition, actively driven tools (4), chassis or trailing members (2) can also serve to generate distribution and thus reduce the required traction of the tractor (36).

The replaceable tool module is connected to the modular support via a quick-coupling interface (19) according to the invention. After the tool module has been coupled, the storage medium (22) is read out via a data interface (21) of the machine system, and the information is transmitted to the ECU (5) and evaluated. This information is used, for example, to identify the tool module (4) and set various process parameters (including working depth, working speed, etc.). In addition, information relating to the tool module (2) and work process can also be stored in a non-local storage (6). In this case, the data are obtained via a corresponding interface (12).

A coupling mechanism (17) and, if applicable, a height-adjustable chassis and/or height-adjustable tractor standard interface (e.g., tractor three-point hitch) adjusts and controls the tool module (4) and, if applicable, the entire machine system in the vertical direction. During transport, the tool module (4) is moved such that a defined ground clearance arises between the tools and the ground. When in the working position, the tool module (4) is in a defined position relative to the ground. Referring to the example of soil cultivation, tool module (4) is guided at a defined working depth by the coupling mechanism (17). The working depth can be constant during the entire work process or can be variably adjusted in a location-specific manner. In this case, the machine system is supported in the front by the towing vehicle (36) and in the rear by the chassis or trailing members (2).

When exchanging or removing a tool, the tool module (4) is separated from the modular machine system at the quick-coupling interface (19) according to the invention. In this case, machine data and/or condition information of the tool module (4) or the individual tools can be stored in the storage medium (22) or the external storage (6) and used for further use, for transport and for storage, and for maintenance and repair.

The tool modules (4) can be stored in devices (26) according to the invention. They enable simple transportation and space-saving storage due to stackability. In addition, these devices can be used for the maintenance and repair of the tool modules (4). The information stored in the storage module (22) can be read out automatically and manually by operating, maintenance and repair staff. For example, a (mobile) reading device (29) can be used for manual reading. After maintenance and repair have taken place, the current tool characteristic values can be stored in the storage medium (22) and thus read out after installation into the modular machine system and used for setting the parameters.

The machine system can be designed as self-propelled, possibly autonomous machines. In this case, the interface to the standard tractor (36) is replaced by a module for energy supply (7) and (primary) drive (2). The further functions remain unaffected.

### REFERENCE SIGNS

1 Support/main frame
2 Chassis
4 A tool or tool group in modular design
5 Control device and/or on-board computer
6 Computer-readable storage medium for computer-readable data
7 Module for energy supply
8 Installation space 1;
9 Installation space 2;
10 Installation space 3;
11 Installation space 4;
12 Interface for the data transmission of computer-readable data
16 Coupling frame
17 Coupling mechanism
19 Interface with quick coupler
21 Data interface
22 Storage medium for computer-readable data on the module side
26 Device for mounting
29 Reader with communication interface
30 Case of need
31 Instruction for repair, maintenance
35 Interface for operation with a towing vehicle
36 Standard tractor as towing vehicle
37 Supply line for energy supply, communication, data connection between machine system and external towing vehicle

1. A device comprising at least one tool module having a quick-coupling interface, at least one support having a quick-coupling interface and designed to hold the at least one tool module, and at least one data processing unit designed for computer-assisted tool management, wherein the support for holding the tool module comprises
at least one support frame,
at least one interface for computer-assisted tool module identification, and
at least one sensor unit,
wherein the support frame comprises at least one quick-coupling interface for a tool module,
wherein the tool module comprises
at least one implement, preferably for use outdoors,
at least one suspension that is compatible with the quick-coupling point on the support frame,
at least one computer-readable storage medium for computer-readable data, and
at least one interface for transmission of computer-readable data.

2. The device according to claim 1, characterized in that the support frame of the support is designed to be adjustable and/or controllable.

3. The device according to claim 1, characterized in that the support for holding the tool module is designed to be adjustable mechanically, electromechanically or in a pressure-actuated manner.

4. The device according to claim 1, characterized in that the quick-coupling interface between the support and the tool module comprises at least one kinematics and/or at least one actuator.

5. The device according to claim 1, characterized in that the sensor unit is selected from inductive sensors, capacitive sensors, acceleration sensors or optical sensors.

6. The device according to claim 5, wherein the sensor unit comprises a combination of the inductive sensors, the capacitive sensors and/or the optical sensors

7. The device according to claim 1, characterized in that the support is designed to be mounted on a chassis or traveling assembly, wherein the chassis or traveling assembly is associated with a tractive unit and/or comprises at least one means for coupling to a tractive unit, and wherein the chassis, traveling assembly or vehicle is designed for mechanical, electromechanical or pressure-induced adjustment of the working height of the tool module.

8. The device according to claim 1, characterized in that an additional support is designed as a storage device, wherein the storage device is designed to be stackable.

9. The device according to claim 1, characterized in that an additional support is designed as a storage device, wherein the storage device is designed for preferred transport by lifting equipment, industrial trucks or agricultural machines.

10. The device according to claims 1 to 9, characterized in that the tool module comprises at least one interface for power transmission and/or an autonomous energy supply

11. A method of computer-assisted tool management of a device according to claim 1, comprising the following steps:
detecting a target condition of at least one tool,
storing the information about the target condition of the respective tool in computer-readable form,
detecting the actual condition of at least one tool,
storing the information about the actual condition of the respective tool in computer-readable form,
identifying correlated target and actual conditions,
comparing correlated target and actual conditions,
outputting a prediction concerning the future actual condition of the respective tool, and
deriving and outputting an action recommendation regarding the respective tool,
wherein computer-assisted tool management differentiates at least between the following action recommendations:
a) no action required,
b) action required due to destruction/loss,
c) action required due to contamination,
d) action required due to wear, and
e) action required due to insufficient data availability.

12. The method according to claim 11, characterized in that the computer-readable information of the target and/or actual condition is selected from the list: type of at least one tool, area of application of the tool, previous operating time of the tool, geometric arrangement of at least one tool component, identification feature of the tool component and/or wear of the tool component.

13. (canceled)
